(19) United States
(12) Patent Application Publication
(10) Pub. No.: US 2026/0094991 A1
(43) Pub. Date: Apr. 2, 2026

(54) SEALED ELECTRICAL CONNECTOR INCLUDING A SEALING WALL AND TRUNNIONS

(71) Applicant: Aptiv Technologies AG, Schaffhausen (CH)

(72) Inventors: Nicholas DURSE, Youngstown, OH (US); Michael MELLOTT, Youngstown, OH (US); William LOVITZ, Niles, OH (US)

(21) Appl. No.: 19/336,601

(22) Filed: Sep. 23, 2025

Related U.S. Application Data
(60) Provisional application No. 63/701,062, filed on Sep. 30, 2024.

(51) Int. Cl. H01R 13/52

(52) U.S. Cl. CPC H01R 13/5202

(57) ABSTRACT

An electrical connector for sealed applications includes a flange defining an opening surrounded by a sealing wall whose inner surface engages a resilient seal of a corresponding mating connector having a mating lever. An insulative housing carrying at least one electrical terminal is received through the opening. One or more trunnions extend from the sealing wall’s outer surface and engage camming slots in the mating lever to draw the connectors together and compress the seal, thereby creating a sealed interface.

### CROSS-REFERENCE TO RELATED APPLICATIONS

This application claims the benefit of and priority to U.S. Provisional Application 63/701,062, titled “Electrical Connector with Lever Lock Direct Mate Technology”, filed September 30, 2024, the contents of which are incorporated by reference herein.

### TECHNICAL FIELD

The subject matter disclosed herein relates to sealed electrical connectors and, in particular, to a sealed high voltage connector with a lever-based locking feature.

### BACKGROUND

Traditionally, high-voltage (HV) electrical connectors have used a header with a large flange for bolting to the surface of an electrical device, such as a battery pack. The flange provides sealing and shielding functions for the electrical connector. The bolts and hardware holding the flange to the device being exposed to the environment which presents corrosion and environmental sealing challenges.

Electrical connectors with high current direct contact terminals, such as DCT™ series terminals manufactured by Aptiv PLC, have relied in the past on a bolt driven mate assist on the harness connector. A lever lock was not used due to the complexity in tooling or the design not accommodating a lever lock option.

### SUMMARY

In some aspects, the techniques described herein relate to an electrical connector configured for a sealed application which includes a flange having an opening extending through the flange, the opening surrounded by a sealing wall extending from the flange. An inner surface of the sealing wall is configured to engage a resilient seal of a corresponding mating connector including a mating lever. The opening is configured to receive at least one electrical terminal disposed within an insulative housing. The electrical connector further includes one or more trunnions extending from an outer surface of the sealing wall. The one or more trunnions are configured to be received in and engage camming slots in the mating lever.

### BRIEF DESCRIPTION OF THE DRAWINGS

FIG. 1 is an exploded of an electrical connector assembly including a flanged connector and a mating lever lock connector according to some embodiments.

FIG. 2 is an isometric view of the electrical connector assembly of FIG. 1 with the lever lock in an unlocked position according to some embodiments.

FIG. 3 is an isometric view of the electrical connector assembly of FIG. 1 with the lever lock in a locked position according to some embodiments.

FIG. 4 is an isometric view of the flanged connector of FIG. 1 according to some embodiments.

FIG. 5 is an exploded view of the flanged connector of FIG. 4 according to some embodiments.

FIG. 6 is an exploded view of the connector housing of the flanged connector of FIG. 4 according to some embodiments.

FIG. 7 is a close-up isometric view of a trunnion protruding from the flange of FIG. 4 having an asymmetrical profile according to one embodiment.

FIG. 8 is a close-up isometric view of a trunnion protruding from the flange of FIG. 4 having a symmetrical profile according to another embodiment.

FIG. 9 is an isometric view of a rigid protrusion and a cantilevered feature configured to inhibiting rotation of the connector housing relative to the flanged connector of FIG. 4 according to one embodiment.

FIG. 10 is a cross-section view of the rigid protrusion and the cantilevered feature of FIG. 9 according to the one embodiment.

FIG. 11 is an isometric view of a rigid protrusion and a cantilevered feature configured to inhibiting rotation of the connector housing relative to the flange of the flanged connector of FIG. 4 according to another embodiment.

FIG. 12 is a cross-section view of the rigid protrusion and the cantilevered feature of FIG. 11 according to another embodiment.

### DETAILED DESCRIPTION

The present disclosure describes a lever locking electrical connector system well adapted for high voltage applications, such as connecting a wire harness to a battery pack or motor of an electric vehicle.

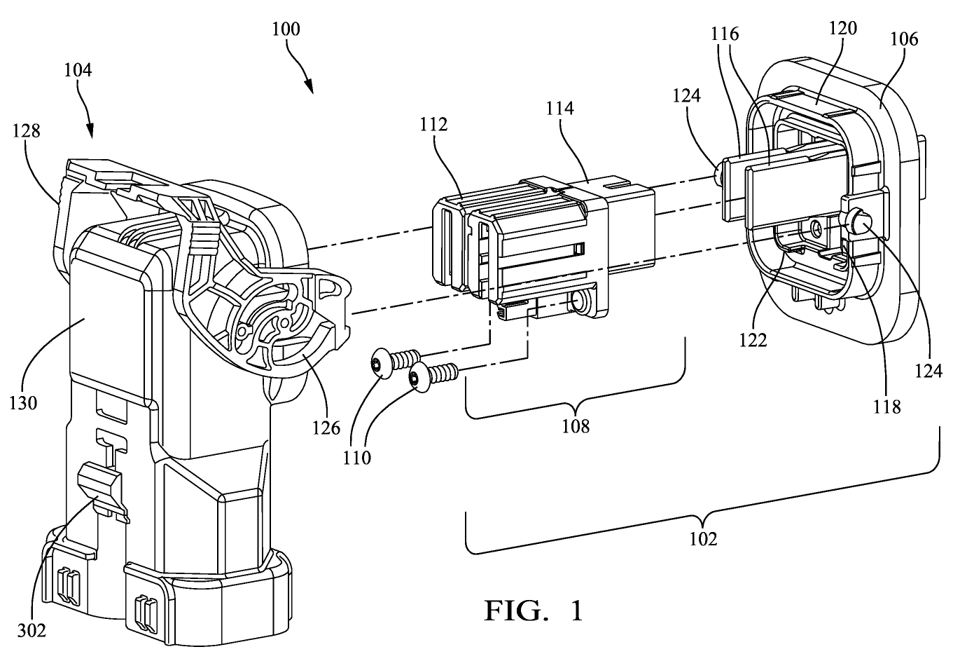

FIG. 1 is an exploded of an electrical connector assembly 100 including a flanged connector 102 and a mating lever lock connector 104. The flanged connector 102 includes a flange 106 to which an electrically insulative connector housing 108 is secured by attachment features 110. The connector housing 108 includes an outer housing 112 and an inner housing 114. The outer and inner housings 112, 114 may be formed of an electrically insulative polymer, such a glass-filled polyamide (PA) or polybutylene terephthalate (PBT).

In the illustrated example, the attachment features 110 are threaded fasteners which allow the connector housing 108 to be disassembled from the flange 106 for servicing the planar terminals 116 contained within the connector housing 108. In alternative embodiments, the attachment features may include flexible releasable locking arms which allow the connector housing 108 to be disassembled from the flange 106. In yet other alternative embodiments, the attachment features may include rivets, cotter pins, heat stakes, or an adhesive that more permanently attaches the connector housing 108 to the flange 106.

The flange 106 includes an opening 118 extending through the flange. The opening is surrounded by a sealing wall 120 extending from the flange 106. An inner surface of the sealing wall 120 is configured to engage a resilient seal within the mating lever lock connector 104, thereby forming an environmental seal to protect the planar terminals 116 from contaminants like dust, water, and electrolytes which may damage the planar terminals 116. The opening is configured to receive the planar terminals 116 contained within the connector housing 108.

The flange 106 also includes a shielding wall 122 extending from the flange 106. The shielding wall 122 at least partially surrounds the opening 118. The shielding wall is located within an inner perimeter of the sealing wall 120. The shielding wall 122 is configured to engage a shield contact within the mating lever lock connector 104.

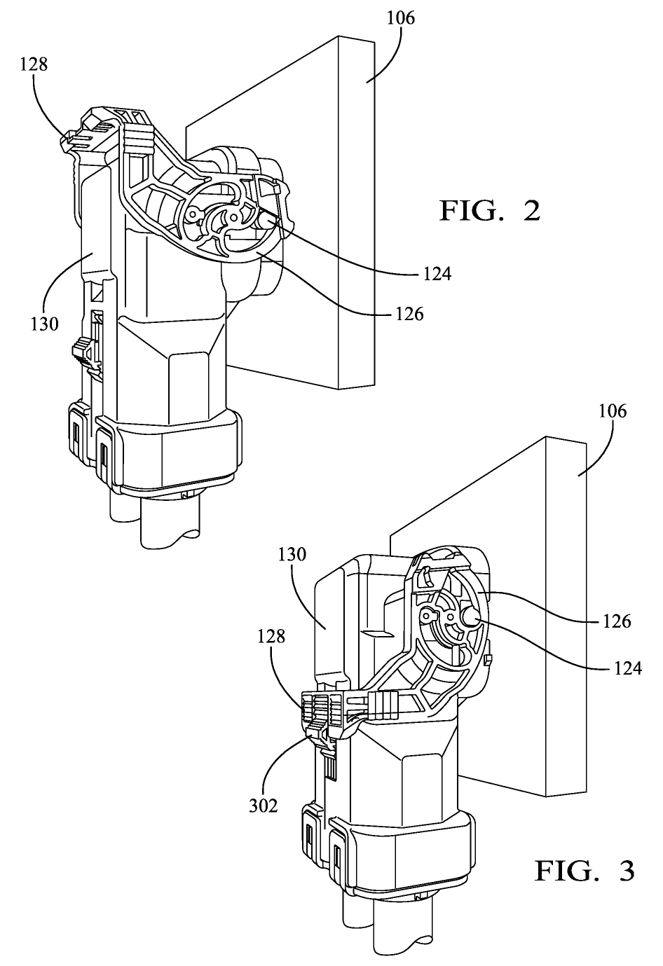

The flange 106 further includes a pair of trunnions 124 extending from opposite sides of an outer surface of the sealing wall 120. The trunnions 124 are configured to be received within a pair of cam slots 126 in a locking lever 128 pivotably attached to a housing 130 of the mating lever lock connector 104 as shown in FIG. 2. As the locking lever 128 is rotated from the unlocked position shown in FIG. 2 to the locked position shown in FIG. 3, the housing 130 is drawn toward the flange 106 by the movement of the trunnions 124 through the pair of cam slots 126. The locking lever 128 may be held in the locked position by a connector position assurance device 302 on the housing 130.

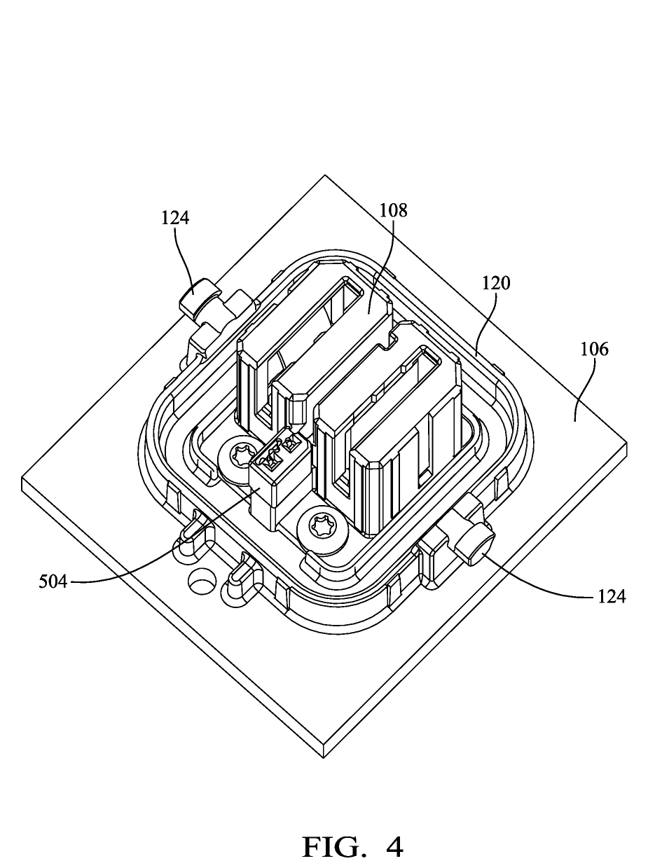

As shown in FIG. 4, the trunnions 124 are integrally formed with the sealing wall 120. In addition, the sealing wall 120 and the shielding wall 122 are integrally formed with the flange 106. The flange 106, the sealing wall 120, the trunnions 124, and the shielding wall 122 are preferably formed of an electrically conductive material, preferably a metallic material such as zinc, magnesium, bronze, aluminum, or an aluminum alloy. The sealing wall 120, the shielding wall 122 and the trunnions 124 may be integrally formed with the flange 106 using molding, casting, and/or machining processes or may be formed using an additive manufacturing (3D printing) process. The integral formation of the shielding wall 122 with the flange 106 may improve shielding performance of the flanged connector 102. The integral formation of the trunnions 124 with the sealing wall 120 from a metallic material may improve the mechanical strength of the trunnions 124, making them less susceptible to breakage due to forces exerted on the trunnions 124 by the locking lever 128. This is a common potential failure point on plastic molded parts. Also, this increased strength can allow for a simpler and smaller trunnion geometry to reduce complexity of the trunnions 124 to improve manufacturability without compromising structural integrity.

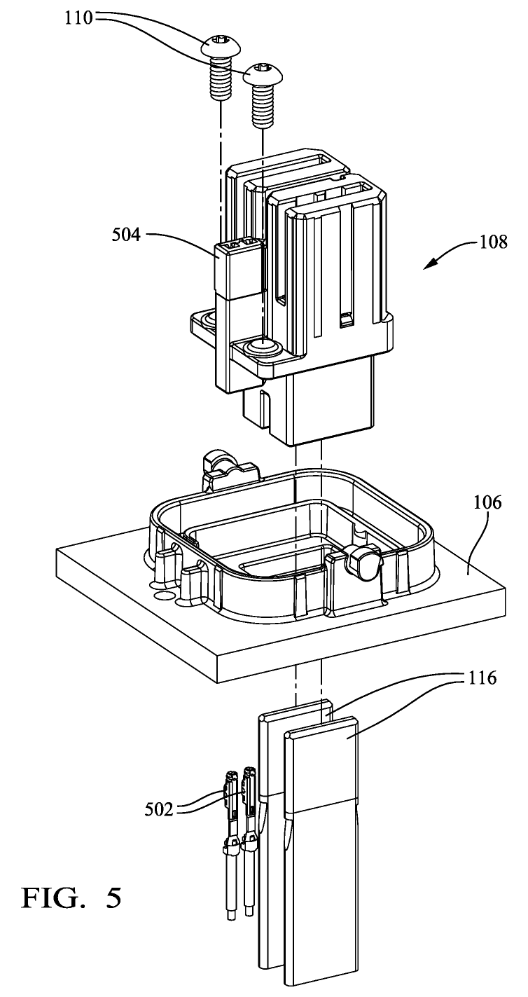

As shown in FIG. 5, the flanged connector 102 further includes a pair of high voltage interlock (HVIL) terminals 502 that signal a controller to disable electrical energy being applied to the terminals 116 until the HVIL terminals 502 are shorted together by a shunt in the mating lever lock connector 104 that shorts the HVIL terminals 502 together when the mating lever lock connector 104 is fully mated with the flanged connector 102, i.e., the locking lever 128 is in the locked position. This is a safety feature to prevent unintended contact with energized terminals 116. The connector housing 108 includes a dedicated terminal cap 504 for the HVIL terminals 502,

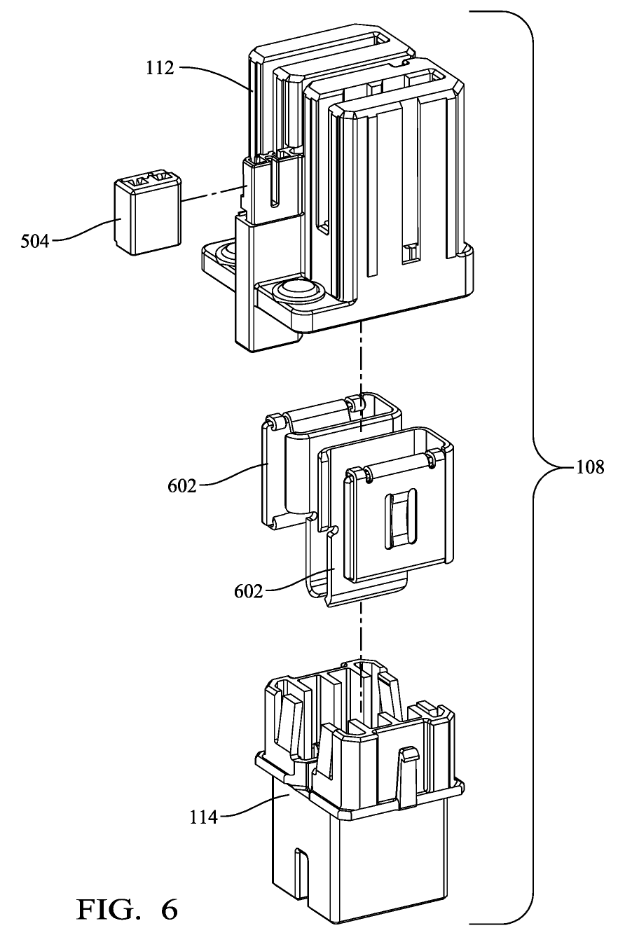

FIG. 6 is an exploded view of the connector housing 108 showing a pair of terminal clamps 602 that are contained within the inner housing 114. These terminal clamps 602 wrap around ends of the terminals 116 and are configured to retain the terminals 116 within the inner hosing. The terminal clamps 602 are also to exert a normal force on mating planar terminals in the mating lever lock connector 104 to hold them in direct contact with terminals 116. In alternative embodiments, the terminal clamps may be disposed within the mating lever lock connector 104 rather than the flanged connector 102. While the electrical terminals shown in the illustrated example are of the direct contact terminal (DCT™) type, other embodiments may include pin and socket terminals, blade and socket terminals, or other known terminal combinations.

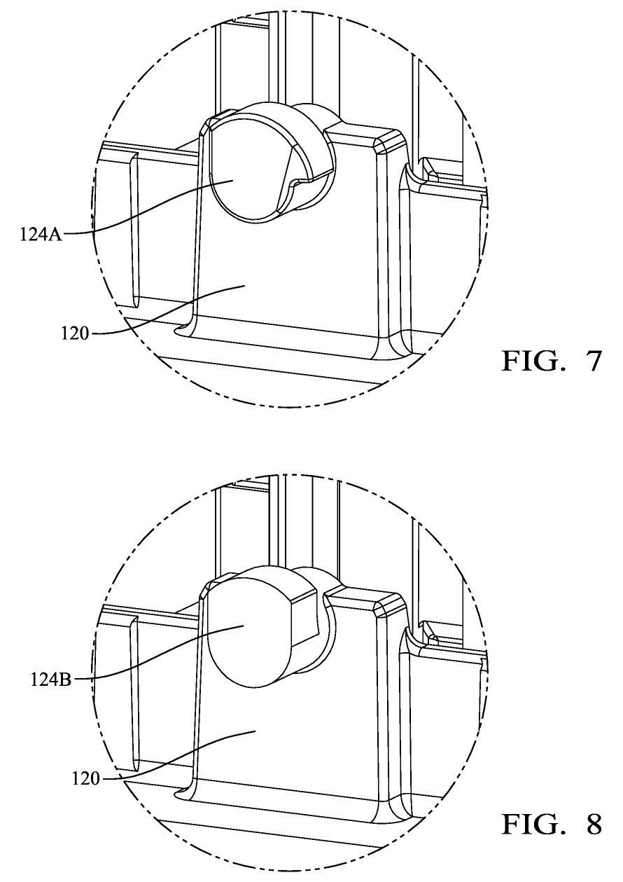

As seen in FIGS. 7 and 8, the trunnions 124 extend from the outer surface of the sealing wall 120 along an axis X. Distal (end) portions of the trunnions 124 have a first axial width that is greater than a second axial with of mesial (base) portions of the trunnions 124. This configuration of the trunnions 124 help hold the trunnions 124 within the cam slots 126 during movement of the locking lever 128. The trunnion 124A shown in FIG. 7 has an asymmetrical profile while the trunnion 124B shown in FIG. 8 has a symmetrical profile.

As shown in FIG. 9 to 12, the flange 106 further includes a rigid protrusion extending from the flange that is configured to engage a cantilevered feature extending from the housing 108. The rigid protrusion and the cantilevered feature are located opposite the attachment features 110 and are configured to cooperatively inhibit rotation of the housing 108 relative to the flange 106. The rigid protrusion and the cantilevered feature are preferably positioned within an inner perimeter of the sealing wall

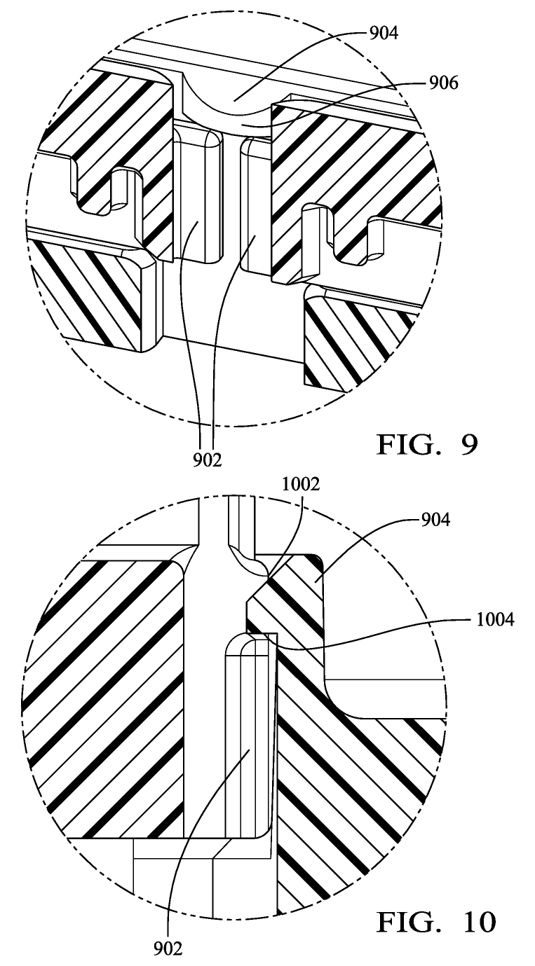

FIGS. 9 and 10 show a first example of the rigid protrusion and the cantilevered feature in which the cantilevered feature has a pair of cantilevered flexible arms 902 that are connected to the housing 108 along a major axis of the cantilevered flexible arms 902 and wherein the rigid protrusion 904 has a chamfered leading edge 1002 and an arcuate profile 906. The chamfered leading edge 1002 of the rigid protrusion is configured to push the cantilevered flexible arms 902 outwardly as the rigid protrusion 904 slides past the cantilevered flexible arms 902. The cantilevered flexible arms 902 flex inwardly to engage a trailing edge 1004 of the rigid protrusion 904 after the rigid protrusion 904 slides past the cantilevered flexible arms 902.

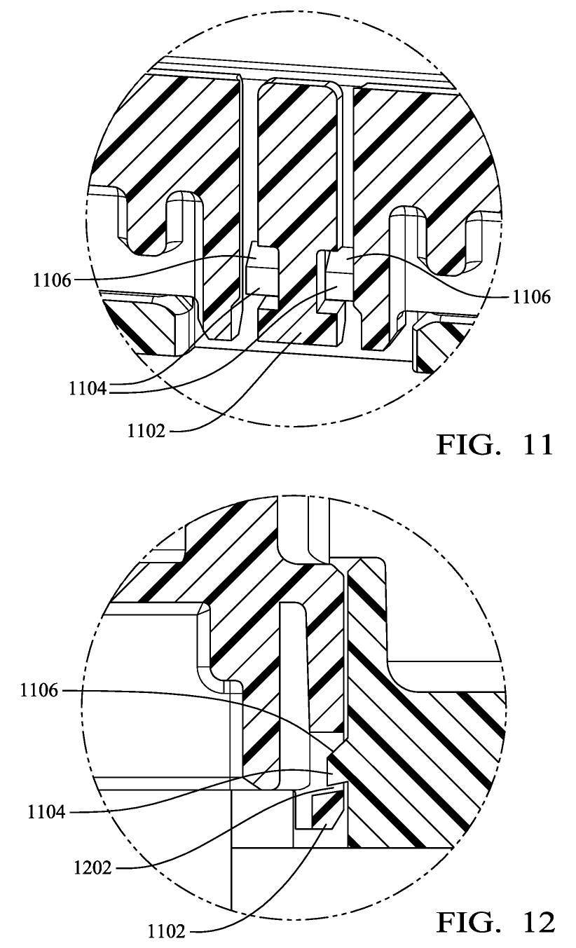

FIGS. 11 and 12 show a second example of the rigid protrusion and the cantilevered feature in which the cantilevered feature has a T-shaped cantilevered arm 1102 and the rigid protrusion has a pair of rigid latches 1104 each having a chamfered leading edge 1106. The chamfered leading edge 1106 of each of the rigid latches 1104 are configured to push the T-shaped cantilevered arm 1102 to flex outwardly as the rigid latches 1104 slide past a distal portion of the T-shaped cantilevered arm 1102. The T-shaped cantilevered arm 1102 flexes inwardly to engage a trailing edge 1202 of the rigid latches 1104 after the rigid latches 1104 past the distal portion of the T-shaped cantilevered arm 1102.

This electrical connector assembly 100 offers a design for applying direct connect terminal (DCT™) terminal technology for mating an electrical connector to an electrical device. The flange 106 is simplified and compacted to allow for use of a lever lock mate assist connector. This compact space envelope results from not requiring a bolted mate assist, so the terminal centerlines may be closer. This design does not drive any significant changes to the mating lever lock connector 104, in this example an Aptiv DCT1400 connector, which makes a more modular use of a direct connect terminal or similar type of connector because it can be used with the flanged connector 102 or a traditional header without changes to the mating lever lock connector 104.

While the illustrated examples are a sealed electrical connector, other embodiments may be envisioned that are configured for use with other sealed connector types, such as fiber optic connectors, pneumatic connectors, hydraulic connectors, or a hybrid connectors combining two or more of these technologies.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Discussion of Possible Embodiments

The following are non-exclusive descriptions of possible embodiments of the present invention.

According to one aspect, an electrical connector configured for a sealed application, includes a flange having an opening extending through the flange. The opening is surrounded by a sealing wall extending from the flange. An inner surface of the sealing wall is configured to engage a resilient seal of a corresponding mating connector including a mating lever. The opening is configured to receive at least one electrical terminal disposed within an insulative housing. The electrical connector also includes one or more trunnions extending from an outer surface of the sealing wall that are configured to be received in and engage camming slots in the mating lever.

The electrical connector of the preceding paragraph can optionally include, additionally and/or alternatively any, one or more of the following features/steps, configurations and/or additional components.

For example, the electrical connector may further include a shielding wall extending from the flange. The shielding wall may at least partially surround the opening. The shielding wall may be located within an inner perimeter of the sealing wall. The shielding wall may be configured to engage a shield contact of the corresponding mating connector.

For example, the one or more trunnions may be integrally formed with the sealing wall.

For example, the sealing wall and the shielding wall may be integrally formed with the flange.

For example, the flange, the sealing wall, the one or more trunnions, and the shielding wall may include an electrically conductive material.

For example, the electrically conductive material may include aluminum.

For example, the electrically conductive material may include a metallic material selected from a group consisting of zinc, magnesium, and bronze.

For example, the one or more trunnions may extend from the outer surface of the sealing wall along an axis. Distal portions of the one or more trunnions may have a first axial width that is greater than a second axial with of mesial portions of the one or more trunnions.

For example, the distal portions may be symmetrical about the axis.

For example, the electrical connector may further include the at least one electrical terminal. The at least one electrical terminal may include a pair of planar terminals.

For example, each of the pair of planar terminals may be surrounded by a clamp configured to hold the pair of planar terminals in compressive contact with a corresponding pair of planar terminals in the corresponding mating connector.

For example, the electrical connector may further include a rigid protrusion extending from the flange configured to engage a cantilevered feature extending from the insulative housing, thereby cooperatively inhibiting rotation of the insulative housing relative to the flange.

For example, the cantilevered feature may include a pair of cantilevered flexible arms that are connected to the insulative housing along a major axis of the cantilevered flexible arms. The rigid protrusion may have a chamfered leading edge and an arcuate profile.

For example, the chamfered leading edge of the rigid protrusion may be configured to push the cantilevered flexible arms outwardly as the rigid protrusion slides past the cantilevered flexible arms. The cantilevered flexible arms may flex inwardly to engage a trailing edge of the rigid protrusion after the rigid protrusion slides past the cantilevered flexible arms.

For example, the cantilevered feature may include a T-shaped cantilevered arm. The rigid protrusion may include a pair of rigid latches each having a chamfered leading edge.

For example, the chamfered leading edge of each of the rigid latches may be configured to push the T-shaped cantilevered arm flexes outwardly as the rigid latches slides past a distal portion of the T-shaped cantilevered arm. The T-shaped cantilevered arm may flex inwardly to engage a trailing edge of the rigid latches after the rigid latches slide past the distal portion of the T-shaped cantilevered arm.

For example, the rigid protrusion and the cantilevered feature may be positioned within an inner perimeter of the sealing wall.

For example, the flange may be integrally formed with an electrically conductive housing of an electrical device.

For example, the flange may be configured to be attached to an electrically conductive housing of an electrical device.

For example, the at least one electrical terminal and the insulative housing may be configured to be removably attached to the flange by an attachment feature.

1. An electrical connector configured for a sealed application, comprising:
a flange having an opening extending through the flange, the opening surrounded by a sealing wall extending from the flange, an inner surface of the sealing wall configured to engage a resilient seal of a corresponding mating connector comprising a mating lever, the opening configured to receive at least one electrical terminal disposed within an insulative housing; and
one or more trunnions extending from an outer surface of the sealing wall and configured to be received in and engage camming slots in the mating lever.

2. The electrical connector in accordance with claim 1, further comprising a shielding wall extending from the flange, the shielding wall at least partially surrounding the opening, the shielding wall being located within an inner perimeter of the sealing wall, and the shielding wall configured to engage a shield contact of the corresponding mating connector.

3. The electrical connector in accordance with claim 2, wherein the one or more trunnions are integrally formed with the sealing wall.

4. The electrical connector in accordance with claim 3, wherein the sealing wall and the shielding wall are integrally formed with the flange.

5. The electrical connector in accordance with claim 4, wherein the flange, the sealing wall, the one or more trunnions, and the shielding wall comprises an electrically conductive material.

6. The electrical connector in accordance with claim 5, wherein the electrically conductive material comprises aluminum.

7. The electrical connector in accordance with claim 5, wherein the electrically conductive material comprises a metallic material selected from a group consisting of zinc, magnesium, and bronze.

8. The electrical connector in accordance with claim 2, wherein the one or more trunnions extend from the outer surface of the sealing wall along an axis and wherein distal portions of the one or more trunnions have a first axial width that is greater than a second axial with of mesial portions of the one or more trunnions.

9. The electrical connector in accordance with claim 8, wherein the distal portions are symmetrical about the axis.

10. The electrical connector in accordance with claim 1, further comprising the at least one electrical terminal, wherein the at least one electrical terminal comprises a pair of planar terminals.

11. The electrical connector in accordance with claim 10, wherein each of the pair of planar terminals is surrounded by a clamp configured to hold the pair of planar terminals in compressive contact with a corresponding pair of planar terminals in the corresponding mating connector.

12. The electrical connector in accordance with claim 1, further comprising a rigid protrusion extending from the flange configured to engage a cantilevered feature extending from the insulative housing, thereby cooperatively inhibiting rotation of the insulative housing relative to the flange.

13. The electrical connector in accordance with claim 12, wherein the cantilevered feature comprises a pair of cantilevered flexible arms that are connected to the insulative housing along a major axis of the cantilevered flexible arms and wherein the rigid protrusion has a chamfered leading edge and an arcuate profile.

14. The electrical connector in accordance with claim 13, wherein the chamfered leading edge of the rigid protrusion is configured to push the cantilevered flexible arms outwardly as the rigid protrusion slides past the cantilevered flexible arms and wherein the cantilevered flexible arms flex inwardly to engage a trailing edge of the rigid protrusion after the rigid protrusion slides past the cantilevered flexible arms.

15. The electrical connector in accordance with claim 12, wherein the cantilevered feature comprises a T-shaped cantilevered arm and wherein the rigid protrusion comprises a pair of rigid latches each having a chamfered leading edge.

16. The electrical connector in accordance with claim 15, wherein the chamfered leading edge of each of the rigid latches are configured to push the T-shaped cantilevered arm flexes outwardly as the rigid latches slides past a distal portion of the T-shaped cantilevered arm and wherein the T-shaped cantilevered arm flexes inwardly to engage a trailing edge of the rigid latches after the rigid latches slide past the distal portion of the T-shaped cantilevered arm.

17. The electrical connector in accordance with claim 12, wherein the rigid protrusion and the cantilevered feature are positioned within an inner perimeter of the sealing wall.

18. The electrical connector in accordance with claim 1, wherein the flange is integrally formed with an electrically conductive housing of an electrical device.

19. The electrical connector in accordance with claim 1, wherein the flange is configured to be attached to an electrically conductive housing of an electrical device.

20. The electrical connector in accordance with claim 1, wherein the at least one electrical terminal and the insulative housing are configured to be removably attached to the flange by an attachment feature.
